(19) United States
(12) Patent Application Publication
(10) Pub. No.: US 2022/0374443 A1
(43) Pub. Date: Nov. 24, 2022

(54) GENERATION OF DATA PIPELINES BASED ON COMBINED TECHNOLOGIES AND LICENSES

(71) Applicant: AT&T Intellectual Property I, L.P., Atlanta, GA (US)

(72) Inventors: James Fan, San Ramon, CA (US); Steven Polston, Flemington, NJ (US); Sanjay Agraharam, Marlboro, NJ (US); Arun Gupta, Manalapan, NJ (US); Michelle Martens, Freehold, NJ (US)

(21) Appl. No.: 17/324,024

(22) Filed: May 18, 2021

(51) Int. Cl. G06F 16/25; G06F 16/2455; G06F 16/28

(52) U.S. Cl. CPC G06F 16/254; G06F 16/24564; G06F 16/284

(57) ABSTRACT

A processing system including at least one processor may perform a method including receiving a data request, executing a request fulfillment module to determine at least one information model and at least one executable flow associated with the data request, determining that at least one combining module is to be applied to the data request based on the at least one information model and the at least one executable flow, applying the at least one combining module to the data request, and generating a data pipeline to transmit data to a target that initiated the data request, wherein the data pipeline is generated in accordance with the at least one combining module that is applied.

The present disclosure relates generally to data pipelines for transferring batch and streaming data via communications networks, and more particularly to methods, computer-readable media, and apparatuses for generating a data pipeline based on combined technologies and licenses.

### BACKGROUND

A data pipeline is a set of data processing elements connected in series, where the output of one element is the input of the next element. The elements of a data pipeline may operate in parallel or in a time-sliced fashion. In addition, some amount of buffer storage may be provided between other elements. One subset of data pipelines includes extract, transform, and load (ETL) systems, which extract data from a data source, transform the data, and load the data into a database or data warehouse. ETL pipelines may run in batches, meaning that the data is moved in one large chunk at a specific time to the target, e.g., in regular scheduled intervals. A data pipeline is a broader term that refers to a system for moving data from one or more sources to one or more targets in a computing network environment. The data may or may not be transformed, and it may be processed in real time (or streaming) instead of batches. When the data is streamed, it may be processed in a continuous flow which is useful for data that is continuously updating, such as a data from a traffic monitoring sensor. In addition, the data may be transferred to any number of targets, which may include databases or data warehouses, as well as any number of automated systems, operator/user terminals, and so forth.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a more detailed block diagram of an example combining module of a Data Pipeline Intelligent Controller (DPIC) of the present disclosure;

FIG. 3 illustrates a flowchart of an example method for generating a data pipeline based on combined functions, technologies, and/or licenses; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

The present disclosure broadly discloses a method, non-transitory computer readable medium, and apparatus for generating a data pipeline based on combined technologies and licenses. In one example, a method performed by a processing system includes receiving a data request, executing a request fulfillment module to determine at least one information model and at least one executable flow associated with the data request, determining that at least one combining module is to be applied to the data request based on the at least one information model and the at least one executable flow that are determined, applying the at least one combining module to the data request, and generating a data pipeline to transmit data to a target that initiated the data request, wherein the data pipeline is generated in accordance with the at least one combining module that is applied.

In another example, a non-transitory computer-readable medium may store instructions which, when executed by a processing system in a communications network, cause the processing system to perform operations. The operations may include receiving a data request, executing a request fulfillment module to determine at least one information model and at least one executable flow associated with the data request, determining that at least one combining module is to be applied to the data request based on the at least one information model and the at least one executable flow that are determined, applying the at least one combining module to the data request, and generating a data pipeline to transmit data to a target that initiated the data request, wherein the data pipeline is generated in accordance with the at least one combining module that is applied.

In another example, a device may include a processing system including at least one processor and non-transitory computer-readable medium storing instructions which, when executed by the processing system when deployed in a communications network, cause the processing system to perform operations. The operations may include receiving a data request, executing a request fulfillment module to determine at least one information model and at least one executable flow associated with the data request, determining that at least one combining module is to be applied to the data request based on the at least one information model and the at least one executable flow that are determined, applying the at least one combining module to the data request, and generating a data pipeline to transmit data to a target that initiated the data request, wherein the data pipeline is generated in accordance with the at least one combining module that is applied.

The present disclosure may generate a data pipeline based on combined technologies and licenses in a real-time license combiner (RLC) in support of next generation data pipelines (RLC-NGDP). The NGDP may be an architecture under the control of a Data Pipeline Intelligent Controller (DPIC). A DPIC may control all the elements of a data pipeline to enable the data pipeline to create a suitable response to satisfy a client request. The functions, or modules of a DPIC may include, but are not limited to: schedulers, request interpreters, various artificial intelligence/machine learning modules, policy functions, security and privacy enforcement modules, assurance functions, negotiation functions, orchestrators, databases, an abstract symbol manipulator module, a model data schema generator/updater, and so forth.

In one example, a DPIC may create new schemas to handle new source data retrievals and/or to integrate new data pipeline component types, and may assemble and tear down data pipelines in real-time. In one example, a DPIC is flexibly expandable via add-ons, plug-ins, helper applications, and the like. When a client, such as a data scientist, a network operator, an automated computing system, or the like seeks to obtain specified data sets from multiple sources, e.g., to provide to one or more machine learning models as target(s), the client may provide the request by specifying the desired data and the desired target(s), and the DPIC may automatically generate an end-to-end plan to obtain and transmit the right data from the right source(s) to the right target(s). Thus, the present disclosure provides for intelligent control of data pipelines via a DPIC that automatically integrates and directs data pipeline components at a higher level of abstraction. Data pipelines may be constructed dynamically, and on an as-needed basis such that even complex or demanding client requests may be fulfilled without (or with minimal) human interaction, and without component-specific human expertise regarding the various data pipeline components.

In addition, the DPIC may combine different functions, technologies, and/or licenses associated with the technologies and/or proprietary data sources to generate a data pipeline. Combining different functions, technologies, and/or licenses may help improve the efficiency of processing resources, data transmission, and real-time data processing that may occur as data is being transmitted across the data pipeline. Furthermore, combining different functions, technologies, and/or licenses may reduce the number of data pipelines that need to be created. For example, rather than creating multiple data pipelines to transmit data with different functions applied to the data, a single data pipeline can be generated that performs the different functions with available technologies and associated licenses, if applicable.

In many cases, a data pipeline or its associated support functions are in existence but the data pipeline itself may be inactive. In other cases, a data pipeline may not be physically or virtually established, but all the support functions are available in the cloud. In response to a request for data transfer, inactive data pipelines may be activated or a new data pipeline may be formed in real-time.

In one example, a data pipeline component discovery module of a DPIC continuously discovers new or changed conditions in a data pipeline infrastructure. In one example, the DPIC may determine how to fulfill data requests with alternative mechanisms. For instance, the DPIC may determine if intermediate nodes or data stores could be established to improve efficiency or other performance/quality aspects. In one example, a result of a request may be stored as a copy in a source node, in a specified intermediate node, or at one or more target nodes, such that the result may be reused for one or more subsequent requests. The purpose is not to replace the data pipeline's native data fulfillment functions, but rather to assist, suggest, or command how the data pipeline handles its fulfillment aspects.

The DPIC may also ensure that data is well understood. For instance, data sources may be indexed and a requestor may learn upfront what data is available. In accordance with the present disclosure, a data pipeline may be dynamically established and subsequently torn down. Thus, a data pipeline may not always be a persistent entity. In one example, DPIC is aware of each data pipeline that is in existence, and knows each data pipeline's history. In addition, in one example, if a request cannot be automatically satisfied, the DPIC may provide meaningful explanation of the gaps, which may allow data scientists working offline to improve tools/modules at the data pipeline level.

Thus, the DPIC, and/or various modules thereof, may be configured for several use patterns, e.g., including but not limited to: inquiry/browsing, request template/specification and analysis/planning, data source/data pipeline indexing, notification, and request and fulfillment. Interactions of the DPIC with other entities in these patterns may be via any appropriate means, such as: direct or indirect communications; forwarded, routed, or switched communications; application programming interfaces (APIs); bus messages; subscribe-publish events; etc.

Inquiry/browsing—This pattern may be used to verify if a DPIC can arrange the fulfillment of an inquiry. For example, a requestor may browse a data pipeline catalog to select particular data or data set(s), and may send an inquiry to the data pipeline controller, which may then determine and respond with availability (and potentially commitments, reservations, verifications, etc.) along with associated information related to the data/data set(s) that is/are identified in the inquiry, such as: estimated freshness, latency, quality, etc.

Request template/specification and analysis/planning— A requestor may send an actual request to the DPIC for simulated processing, such as a particular template/specification of desired data or data set(s). The DPIC may command and coordinate with data pipeline components to perform analysis, search, planning of functional steps, and so forth, in order to provide informative responses. For example, in some cases the DPIC may return one or more of three potential responses: (1) requesting that more information should be provided, (2) indicating that special authorization may be needed, and (3) providing example(s) of full data/data set response (if possible) or partial data/data set response (e.g., if the requested data/data set(s) is/are large, if “1” or “2” also apply, etc.).

In one example, information models may have associated request templates which may be predefined (e.g., by a creator/administrator of an information model) and/or which may be learned over time as requests are matched to different information models, as feedback on the quality and correctness of the matching is provided by client request submitters, and so forth. In one example, multiple request templates may be stored and maintained in association with an information model. For instance, the same information model may be matched to different requests, which may all relate to a same general type of data delivery, but with somewhat different specifics, such as one or more different data sources, one or more different targets, with or without an intermediate storage node, etc.

It should be noted that information models and associated request templates may have more or less detail, and more or less fixed and/or configurable parameters depending upon the preferences of a system operator, a creator of an information model, etc. For instance, in one example, an information model and/or an associated request template may be for obtaining specific data from specific data sources and delivering to selected targets. In other words, the data and data sources may be fixed and are not further selectable (at least with this particular example information model). However, another information model may be for obtaining selectable data from selectable data sources within a specific area for delivery to selectable targets. In other words, the location or region may be fixed, while the data and the data sources are not fixed and can be selected (e.g., via a request that is crafted in accordance with an associated request template and/or via a custom crafted request that is mapped to the information model). In one example, the request template/specification and analysis/planning use pattern may include providing access to a catalog of request templates from which a client may select a template for use (e.g., for simulated or actual fulfillment of a request).

Data source/data pipeline indexing—The DPIC may add new data sources (or even full data pipelines) to a catalog of data pipeline infrastructure components.

Notification—The DPIC may notify requestors and/or subscribers of new data pipeline components or data pipeline component types. For instance, when a new data pipeline component or data pipeline component type is discovered, the DPIC may notify previous requestors and/or publish/post notifications to those who previously subscribed to the notification messages (e.g., of the particular scope of the new findings).

Request and fulfillment—Stored data set(s) or stream data may be obtained by a requestor or an automated system sending a request or trigger to the data pipeline controller. The request/trigger may be simple in some cases, but may be expected to include (directly or by reference) detailed specification information such that the appropriate data or data set(s) can be identified, prepared, and provided. In one example, the DPIC may first check if the same or a similar request has recently gone through the request template/specification and analysis/planning pattern (e.g., as outlined above), and if so, some portion of the fulfillment process may be omitted for the sake of efficiency (e.g., if various safety/quality assurance criteria are met). For instance, the request specification may be sent to data sources and resulting data may be joined in appropriate node(s) in order to avoid unnecessary work, with final data/data set(s) then being delivered to the requestor.

Feedback—This pattern enables a requestor to provide feedback to the DPIC regarding its automated actions. For instance, a data requester may provide data usage/quality feedback to the data pipeline controller, which can then use the feedback to fine tune various relevant data manipulation processes.

Discovery—this pattern enables the DPIC to discover functionalities of data pipeline functions. The discovery pattern may include two aspects. (1) Proactive discovery, in which a pre-specified model (e.g., information model) may be provided to the data pipeline controller. Based on scheduling and the information model specification, the DPIC may proactively discover newly formed data pipeline components (and/or data pipeline component types) or may discover updates to data pipeline components (and/or data pipeline component types) that may have been modified. (2) Reactive discovery, in which each data pipeline component, once instantiated or modified, may notify the DPIC of its existence. In some cases, where the DPIC engages in a proactive discovery role, the DPIC may follow what is defined in an information model and may verify the existence of underlying data pipeline components (e.g., one or more instances of data pipeline component types which is/are identified in the information model). An information model may also be leveraged in a “reactive” model. In this case, data pipeline components may notify the DPIC of the components' whereabouts and details.

In addition, in one example, when the DPIC becomes aware of a new data source or other data pipeline component (or a new data source type and/or a new data pipeline component type), the DPIC may attempt to derive a default data schema (and for a new data source, to also profile the data). The data schema may be in terms of the symbols that the DPIC is made aware of (e.g., from a provided ontology). A system operator may also validate or correct the automatically-generated data schema. Additionally, the DPIC may validate fresh batches of data from a data source against a previously defined data schema, and any differences in the statistical profile of the new batch versus previous batches may be noted.

Thus, the DPIC supports both data request and data fulfillment. Users no longer need to know the details of how to acquire or reformat the data sets. This is handled by the DPIC configuring the data pipeline instances. The DPIC comprises various modules which collectively function to decompose a single data request into sub-parts. In one example, a DPIC of the present disclosure may dynamically decide alternative ways to obtain the requested data set(s) when one or more data sources are not available. Based on a request, a DPIC may dynamically command a data pipeline to create intermediate nodes which can, for example, act as temporary staging points to optimally accomplish sharing/reuse for performance gains. In addition, a DPIC may generate data schema(s) for new types of data sources and/or data pipeline components (e.g., when data schemas are not provided with these new components).

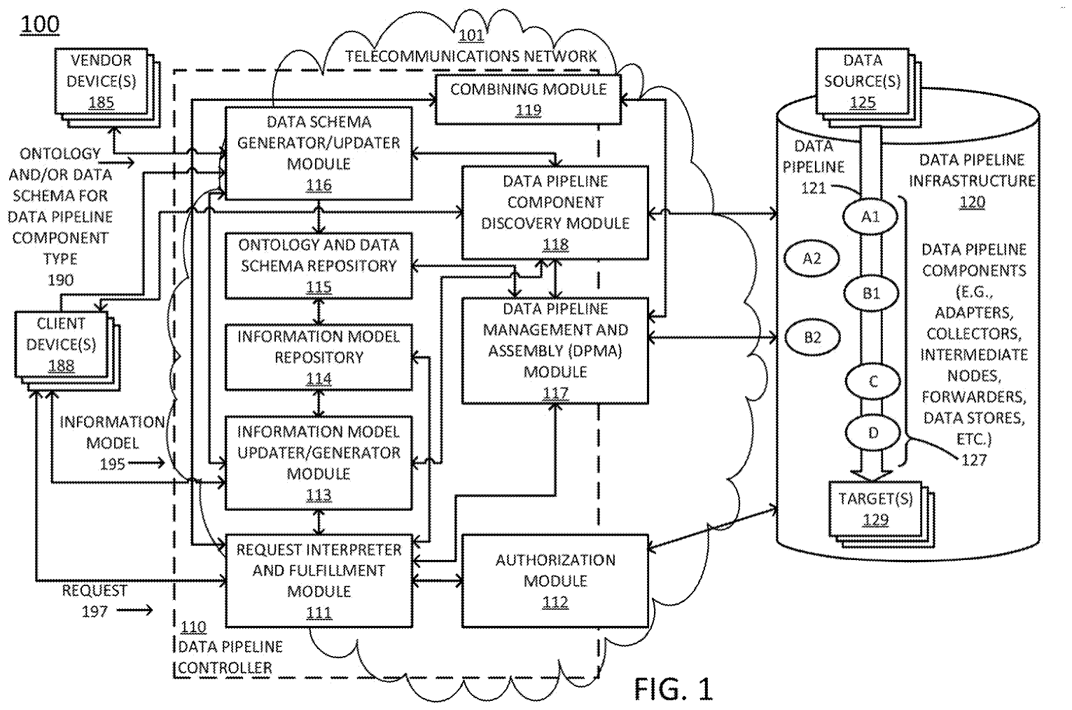

The present disclosures builds on these features of the DPIC to further allow the DPIC to dynamically combine functions, technologies, and/or licenses to make the integrated data pipeline services more efficient and economical. For example, some data pipelines can combine functions over a single data pipeline using available or underutilized technologies that can be applied to data requests. Some license agreements may allow a certain amount or type of usage of the technologies. The present disclosure may determine when use of these technologies are available under these associated licenses to perform combined functions on data requests. These and other aspects of the present disclosure are described in greater detail below in connection with the examples of FIGS. 1-4.

To further aid in understanding the present disclosure, FIG. 1 illustrates an example system 100 in which examples of the present disclosure for generating a data schema for a type of data pipeline component and storing an ontology and the data schema for the type of data pipeline component in a catalog of data pipeline component types may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a telecommunication network 101. Telecommunication network 101 may combine core network components of a cellular network with components of a triple play service network; where triple-play services include telephone services, Internet services and television services to subscribers. For example, telecommunication network 101 may functionally comprise a fixed mobile convergence (FMC) network, e.g., an IP Multimedia Subsystem (IMS) network. In addition, telecommunication network 101 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication network 101 may further comprise a broadcast television network, e.g., a traditional cable provider network or an Internet Protocol Television (IPTV) network, as well as an Internet Service Provider (ISP) network. In one example, telecommunication network 101 may include a plurality of television (TV) servers (e.g., a broadcast server, a cable head-end), a plurality of content servers, an advertising server (AS), an interactive TV/video on demand (VoD) server, and so forth. For ease of illustration, various additional elements of telecommunication network 101 are omitted from FIG. 1.

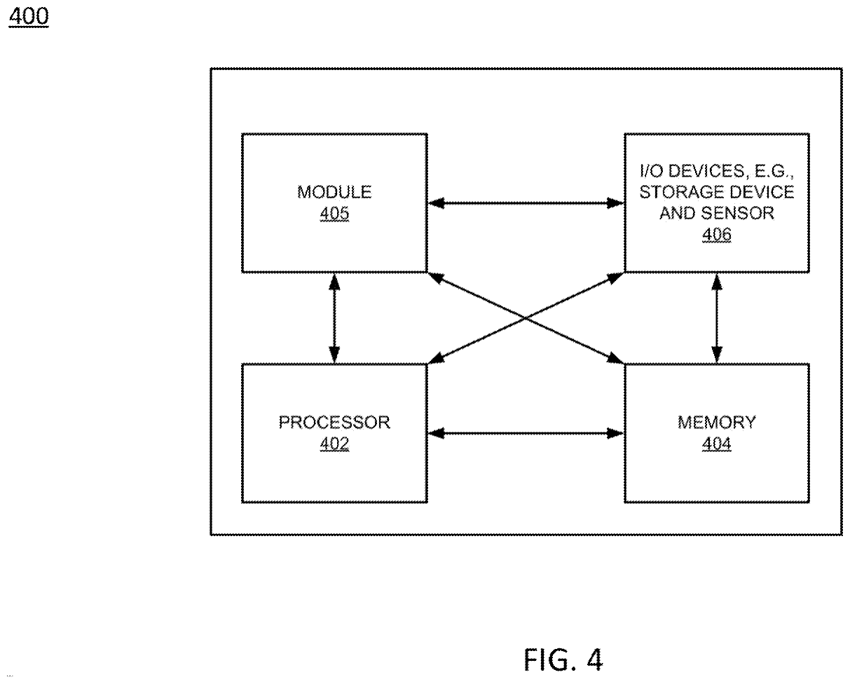

The telecommunication network 101 may be in communication with data pipeline infrastructure 120 and the Internet in general (not shown). In one example, the data pipeline infrastructure 120 may comprise a “public” cloud or “private” cloud infrastructure. For instance, all or a portion of the data pipeline infrastructure 120 may be controlled by a same entity as telecommunication network 101. In such an example, the data pipeline infrastructure 120 may be considered part of the telecommunication network 101. Alternatively, or in addition, all or a portion of the data pipeline infrastructure 120 may be controlled by and/or operated by another entity providing cloud computing services to clients/subscribers. The data pipeline infrastructure 120 may include a plurality of data pipeline components 127, such as adapters, collectors, intermediate nodes, forwarders, data stores, and so forth. The data pipeline infrastructure 120 may comprise servers/host devices (e.g., computing resources comprising processors, e.g., central processing units (CPUs), graphics processing units (GPUs), programmable logic devices (PLDs), such as field programmable gate arrays (FPGAs), or the like, memory, storage, and so forth), which may provide virtualization platforms for managing one or more virtual machines (VMs), containers, microservices, or the like. For instance, in such case the data pipeline components 127 may comprise virtual machines, containers, microservices, or the like, which may provide the various functions of data pipeline components, such as a collector, an adapter, a forwarder, etc. In one example, the data pipeline components 127 may also include dedicated hardware devices, e.g., one or more servers that may comprise one or more adapters, collectors, intermediate nodes, etc. and which may be configured to operate in various data pipelines (but which may not be readily adaptable to provide a different type of service). In one example, the data pipeline components may each comprise a computing system or server, such as computing system 400 depicted in FIG. 4, and may be configured to provide one or more operations or functions in connection with examples of the present disclosure for generating a data schema for a type of data pipeline component and storing an ontology and the data schema for the type of data pipeline component in a catalog of data pipeline component types, as described herein.

In one example, the data pipeline infrastructure 120 may also include one or more data sources 125 and one or more targets 129. However, in another example, these devices or systems may be considered to be outside the data pipeline infrastructure 120. The data sources 125 may include network devices, e.g., routers, switches, multiplexers, firewalls, traffic shaping devices or systems, base stations, remote radio heads, baseband units, gateways, and so forth. The data from the data sources 125 may therefore comprise various types of network operational data, such as: channel quality information, a number of endpoint devices served by a base station, records and/or alerts regarding network anomaly detections, throughput information, link connectivity information, port utilization metrics, and so on. In one example, the data sources 125 may alternatively or additionally comprise sensor devices, e.g., temperature sensors, humidity sensors, wind speed sensors, magnetometers, pressure sensors, etc. Thus, the data from data sources 125 may comprise measurements of temperature, humidity, wind speed, pressure, magnetic field strength and/or direction, and so forth. In still another example, the data sources 125 may alternatively or additionally include digital still and/or video cameras, photograph and/or video repositories, medical imaging repositories, financial data storage systems, medical records storage systems, and so forth. Accordingly, the data that is available from data sources 125 may alternatively or additionally include, images, videos, documents, and so forth. It should be noted that data from various data sources 125 may be filtered and transformed to achieve one or more data sets and/or subsets of data that can be common across a set of data pipelines and data pipeline instances. In one example, the targets 129 may comprise various devices and/or processing systems, which may include various machine learning (ML) modules hosting one or more machine learning models (MLMs). For instance, a first one of the targets 129 may comprise a MLM to process image data and may be trained to recognize images of different animals, a second one of the targets 129 may comprise a MLM to process financial data and may be trained to recognize and alert for unusual account activity, and so forth. Targets 129 may also include user endpoint devices, storage devices, and so forth.

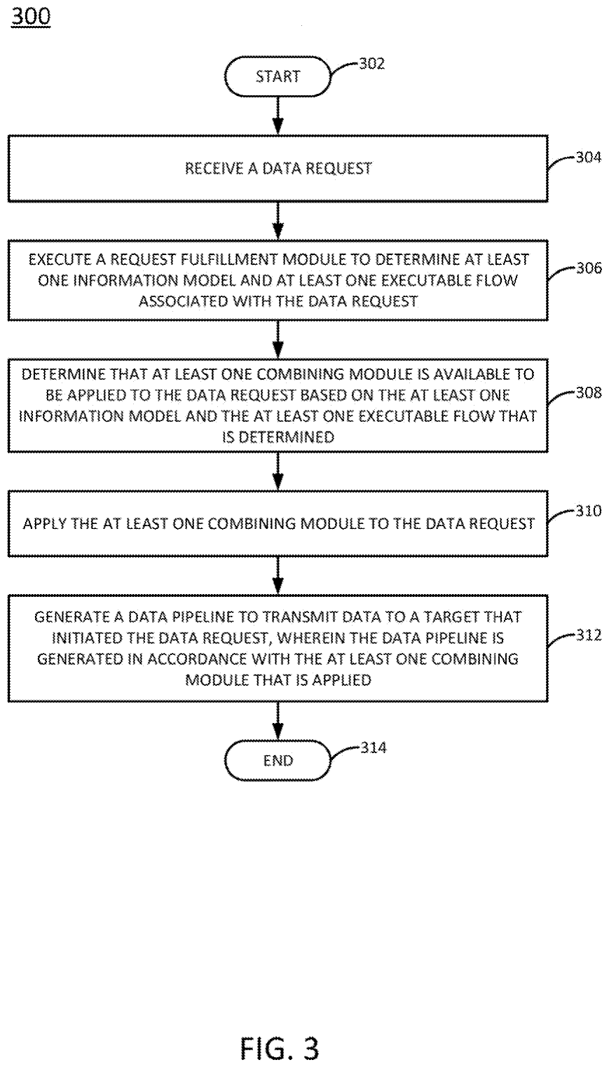

As further illustrated in FIG. 1, telecommunication network 101 may include a data pipeline controller (DPIC) 110. In one example, the DPIC 110 may comprise a computing system or server, such as computing system 400 depicted in FIG. 4, and may be configured to provide one or more operations or functions for generating a data pipeline based on combined functions, technologies, and/or licenses, as described herein. For instance, a flowchart of an example method 300 for generating a data pipeline based on combined functions, technologies, and/or licenses is illustrated in FIG. 3, and described in greater detail below.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the DPIC 110 may include a plurality of modules 111-119 which provide for particular functions of the DPIC 110. For instance, each component/module 111-119 may comprise respective code, executable images, etc., that can be loaded into memory and executed by one or more processors to collectively comprise an operational DPIC 110.

As noted above, each of the data pipeline components 127 may have a data pipeline component type, such as an adapter, collector, forwarder, etc. In one example, for each data pipeline component type, the DPIC 110 may store a respective data schema in the ontology and data schema repository 115. A data schema for a data pipeline component type establishes how a function of a data pipeline component (of the data pipeline component type) is performed at runtime. It includes relationships among data attributes along with a mini-flow (or micro-level flow sequence). In addition, for each data pipeline component type, the ontology and data schema repository 115 may also store a respective ontology for the data pipeline component type. An ontology defines what an instance of the data pipeline component type is and the functions of the data pipeline component instance (e.g., Vendor 3 Adapter 6 Version 2) and its functions (but does not define how the functions are used—this is provided by the data schema). It should also be noted that insofar as the data sources 125 and targets 129 may comprise part of a data pipeline, these devices or systems may also have respective data pipeline component types for which respective ontologies and associated data schemas may be stored by the ontology and data schema repository 115.

In general, an ontology defines classes (also referred to as “concepts” or “attributes”) and properties (also referred to as “slots”) defining features of the classes. As described herein, each data pipeline component type has its own ontology. However, in some taxonomies, each data pipeline component type may comprise its own “class” in a singular ontology or knowledge base of “data pipeline component types” with additional attributes of the data pipeline component type comprising “sub-classes” in one or more layers below the “class” layer. The ontologies for different data pipeline component types may thus be considered “classes” according to some interpretations. In one example, the format of an ontology may be defined by an operator of the DPIC 110. For instance, an ontology format may have a hierarchy of layers or levels, there may be certain required classes, certain required properties, etc., certain required class restrictions, certain required values for one or more properties, class restrictions, etc., and so on.

In one example, for each new data pipeline component type that becomes available, a vendor may provide an associated ontology. In some cases, a vendor of a new data pipeline component type may also provide an associated data schema. This is illustrated in FIG. 1 where an ontology and/or data schema for a data pipeline component type 190 may be input to the data schema generator/updater module 116. For instance, the ontology and/or data schema for a data pipeline component type 190 may be provided via one of the vendor devices 185. In an example where the vendor has provided both an ontology and a data schema, the data schema generator/updater module 116 may simply store a record for the new data pipeline component type comprising the ontology and the data schema in the ontology and data schema repository 115. However, where only an ontology is provided, the data schema generator/updater module 116 may automatically generate a data schema based upon the ontology and store the record comprising the ontology and the data schema in the ontology and data schema repository 115.

In particular, the data schema generator/updater module 116 may determine a similarity between the new type of data pipeline component and one or more existing types of data pipeline components having records in the ontology and data schema repository 115. In one example, the similarity between the new type of data pipeline component type and an existing type of data pipeline component may be quantified based upon a congruence between the ontology of the new type of data pipeline component (e.g., a first ontology) and the ontology of the existing type of data pipeline component (e.g., a second ontology). For example, the congruence may be based upon a number of matches between classes, properties, and/or class restrictions (broadly, “features”) of the first ontology and the classes, properties, and/or class restrictions (e.g., “features”) of the second ontology. In one example, there may be different weights applied for matches among different features e.g., depending upon the level of the features within a hierarchy of the ontology format, for example.

In one example, the data schema generator/updater module 116 may copy or provide the data schema for the best matching (e.g., the highest congruence measure or score) existing type of data pipeline component as a template for a data schema for the new type of data pipeline component. In one example, the data schema generator/updater module 116 may provide a notification to an operator of the DPIC 110, e.g., at one of the client devices 188, indicating the automatic selection of a data schema template for the new type of data pipeline component. In one example, the operator may then approve of the template for use as the data schema for the new type of data pipeline component. In one example, the operator may make changes or modifications to the template, and provide the changes/modifications to the data schema generator/updater module 116. In one example, data schemas for a top X matching data pipeline components may be returned to the operator, from which the operator may browse and select one of the data schemas as a template (and which may be unmodified, or which may be modified by the operator) that is returned to the data schema generator/updater module 116. Thus, the operator may verify that the data schema generator/updater module 116 is generating valid data schemas. The data schema generator/updater module 116 may then store the template (either modified or unmodified) as the data schema for the new type of data pipeline component, along with the respective ontology, in the ontology and data schema repository. Instances of the new type of data pipeline component may then be made available for use in the data pipeline infrastructure 120.

To support the fulfillment of requests by the DPIC 110, there may be a catalog of predefined “information models,” stored in information model repository 114. The information models may comprise specifications for data pipelines for various use cases. For instance, in one example each “task type” may have an associated information model. In another example, there may be a number of information models associated with each task type. For instance, a first information model associated with the task type of “market intelligence” may relate to “cellular,” and a second information model associated with the task type of “market intelligence” may relate to “VoIP”. In one example, each information model may be associated with or may comprise metadata relating to one or more of: a name, a region, a task type, a technology, and various other types of parameters. As illustrated in FIG. 1, an information model 195 may be submitted by an operator via one of the client devices 188 to the information model updater/generator module 113, which may store the information model in information model repository 114. Once stored in the information model repository 114, the information model 195 may then be used in fulfillment of requests (e.g., requests which are matched to the information model 195).

As noted above, each information model may comprise a specification for a data pipeline. For instance, each information model may comprise hooks to a plurality of data schemas. In one embodiment, one of the hooks may be to invoke a combining module 119, discussed in further details below. The data schemas may be for a plurality of data pipeline component types. As also noted above, the data schemas are specific to particular component types, and provide information on how each of the data source(s) and/or data pipeline component 127 may be utilized, accessed, interacted with, etc. For instance, data pipeline components 127 may include components of various component types, such as: adapters, collectors, intermediate nodes, forwarders, data stores, and so forth. For instance, data pipeline components 127 may include two components of type “A” (e.g., A1 and A2), two components of type “B” (e.g., B1 and B2), and one component each of component types “C” and “D.” In the present example, information model 195 may comprise or provide a specification which may result in the establishment and/or reconfiguration of the data pipeline 121, which may include A1, B1, C, and D from data pipeline components 127. In one example, the information model, or specification, may include a plurality of mini-specifications for driving data retrievals and data joins. For instance, each mini-specification may be tailored to a respective data source (or data source type). In one example, a higher-level specification may be delivered to intermediate points to merge data streams. The specification(s) may be configured based upon the data schemas of respective data pipeline component types and the overall sequence of the information model 195.

A mini-specification may also be tailored to a set of pipeline instances where data from a more general view is filtered or enriched for their instance-specific scopes. For example, data fulfillment, management and assembly modules may efficiently optimize synergies across pipeline requirements, maintain data source updates from sources, and utilize transformation processes to map those updates to pipeline instance requirements, and manage filtering, enriching, and propagating the updates into pipeline instances for data ingestion. Using the information models and data pipeline requirements, the DPIC 110 may optimize pipeline infrastructure workload requirements to maximize and manage synergies across existing/new controller types to ensure data source updates occur to fulfill data pipeline instance requirement and service level agreements (SLAs), and to further achieve economies of scale. In one embodiment, the DPIC 110 may apply the combining module 119 to maximize and manage synergies across existing data pipelines (e.g., modify an existing pipeline) or create new pipelines, as discussed in further details below.

In one example, a new information model, such as information model 195, may lead to the discovery of a new data pipeline component type. For instance, an information model may assume the existence of a data pipeline component type for which there is no record in the ontology and data schema repository 115. In such case, the information model updater/generator module 113 may notify the operator via the client device 188 that an ontology and data schema are missing for this assumed-to-be new data pipeline component type. In one example, the operator of client device 188 may provide an ontology, a data schema, or both, which may be provided to the data schema generator/updater module 116. In another example, the operator may contact a vendor, which may be requested to provide an ontology and/or a data schema.

To further illustrate the functions and features of DPIC 110, an example request 197 for delivery of data from one or more of the data sources 125 to one or more of the targets 129 may be processed by the DPIC 110 as follows. First, the request 197 may be crafted via a client device 188, which may specify a desired delivery of data from one or more of the data sources 125 to one or more of the targets 129. It should be noted that in one example, the request 197 may comprise a “trigger,” e.g., where the requesting client device 188 is an automated system. The request 197 may identify specific types of data, specific fields of data, specific sources or types of sources, geographic locations of sources or logical groupings of sources (e.g., all routers within a given network region, all devices in a subnet, all base stations in a selected state, wind speed information for a selected geographic area for a selected time period, all captured images or video in a selected area for a selected period of time, etc.). In one example, a user may generate the request 197 in accordance with a request template, such as in accordance with the example request template/specification and analysis/planning use pattern described above.

In one example, the request 197 may initially be received and processed via the request interpreter and fulfillment module 111 of DPIC 110. The request interpreter and fulfillment module 111 may first attempt to match the request 197 to a most applicable information model. For instance, the request interpreter and fulfillment module 111 may first parse the request to determine which data sources 125 are implicated, the data of data sources 125 that is being requested, the target(s) 129 to which the data is to be delivered, etc. The request 197 may be simple in some cases, but may include (directly or by reference) detailed specification information such that the appropriate data or dataset(s) can be identified, prepared, and provided. Note that in some cases, the request interpreter and fulfillment module 111 may first check if a same request has recently been processed by the DPIC 110, and if so, some portions of the fulfillment process may be omitted for the sake of efficiency (e.g., if various safety/quality assurance criteria are met). For instance, a specification for the request 197 may be sent to data sources 125 and resulting data may be joined in appropriate node(s) (e.g., data pipeline components 127) in order to avoid unnecessary work, with final data/dataset(s) then being delivered to the desired target(s) 129. Otherwise, additional analysis and planning may first be executed.

In one example, the request interpreter and fulfillment module 111 may be configured to process requests that may be in accordance with various Data Definition Languages (e.g., Structured Query Language (SQL), eXtensible Markup Language (XML) Schema Definition (XSD) Language, Java Script Object Notation (JSON) Schema, etc.). In one example, the request interpreter and fulfillment module 111 comprises an abstract symbol manipulator that extracts symbols from data definition languages and handles rules relating the symbols. As such, the DPIC 110 may handle any data for which descriptor symbols have been provided.

In one example, the DPIC 110 may map the request 197 to a most appropriate information model. For instance, the request 197 may comprise metadata relating to one or more names (e.g., of one or more of the data sources 125, targets 129, types of data sources, and/or types of targets, etc.), one or more regions (e.g., a town, a county, a state, a numbering plan area (NPA), a cell and/or a cluster of cells, a subnet, a defined network region (e.g., a marketing area), etc.), one or more task types (e.g., “market intelligence,” “network load balancing,” “media event support” (e.g., data analysis for large network-impacting events, such as for large concerts, sporting events, etc.), and so forth), a technology (e.g., cellular, Voice over Internet Protocol (VoIP), fiber optic broadband, digital subscriber line (DSL), satellite, etc.), and/or various additional parameters. Such metadata, or parameters, may be explicitly defined in the request 197 as particular metadata fields or may be extracted from the terms of the request 197 (e.g., identified in a query in accordance with a particular Data Definition Language). In any case, the request interpreter and fulfillment module 111 may identify various metadata/parameters of the request 197 and may provide such terms to the information model repository 114.

The information model repository 114 may store a plurality of “information models” (e.g., a catalog or data store). The information models may comprise specifications for data pipelines for various use cases. For instance, in one example each “task type” may have an associated information model. In another example, there may be a number of information models associated with each task type. For instance, a first information model associated with the task type of “market intelligence” may relate to “cellular,” and a second information model associated with the task type of “market intelligence” may relate to “VoIP.” In one example, each information model may be associated with or may comprise metadata relating to one or more of: a name, a region, a task type, a technology, and various other types of parameters.

In one example, the information model repository 114 may map the request to one or more of the information models. For instance, the information model repository 114 may map the request to the at least the first information model based upon a congruence between the metadata of the request and the metadata of each of the one or more information models. For instance, an information model having metadata that most closely matches the metadata of the request 197 may be identified. In one example, the top X information models having the closest matches to the metadata of the request 197 may be identified. The matching of the request 197 to each information model may be scored based upon a number of metadata fields that match. In one example, some fields may be weighted such that a match (or lack thereof) with respect to a given metadata field may have a greater or lesser impact on an overall score for the congruence, or match, between a given request and a particular information model. In one example, the top matching information model, or the top X matching information models may then be returned to the request interpreter and fulfillment module 111. It should be noted that in another example, the matching may be performed via the request interpreter and fulfillment module 111. For instance, the request interpreter and fulfillment module 111 may scan the information models in the information model repository 114 to determine matching scores for different information models. However, in any case, the request interpreter and fulfillment module 111 may select one of the information models (e.g., the top matching information model) for use in establishing and/or reconfiguring a data pipeline to fulfill the request 197. It should be noted that in one example, the request 197 may be submitted in accordance with a request template that may be matched to the information model 195. In such case, the request interpreter and fulfillment module 111 may select the information model 195 based upon the stored association between the request 197 and the information model 195. It should also be noted that in one example, the request interpreter and fulfillment module 111 may provide user tendency, and behavioral tracking and analytics. For instance, the request interpreter and fulfillment module 111 may provide an enhanced user experience in which the request interpreter and fulfillment module 111 may recognize the requestor and may use the past tendency to quickly identify and suggest one or more relevant information models.

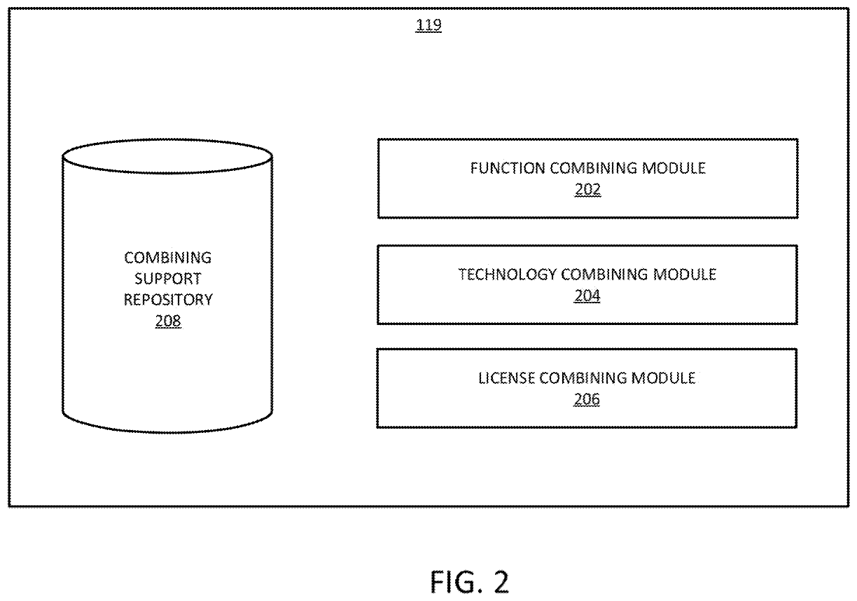

In one example, the request interpreter and fulfillment module 111 may access the combining module 119 to determine if functions, technologies, and/or licenses can be combined to improve efficiency of the data pipeline. Details of the combining module 119 are illustrated in FIG. 2, and discussed in further details below.

In one example, the request interpreter and fulfillment module 111 may provide a notification of the selected information model(s) to the client device 188 that submitted the request 197. In one example, the notification may provide an opportunity for the client device 188 to submit a confirmation to the request interpreter and fulfillment module 111 to proceed with the selected information model (or instead to select one of the suggested information models for use). Likewise, the notification may provide an opportunity for the client device 188 to decline a selected information model. In such case, the request interpreter and fulfillment module 111 may provide one or more additional information models as suggestions (e.g., one or more of the next top X of the closest matching information models). Alternatively, or in addition, the notification may provide the client device 188 with the opportunity to modify a selected information model, or to create a new information model using the selected information model as a template (e.g., along with possible additional modifications). For instance, a user of the client device 188 submitting the request 197 may be aware of a new type of data pipeline component that is desired to be included in the eventual data pipeline. As such, the user may modify the information model and submit as a change to the information model, or may submit as a new information model.

In one example, for each new information model that is submitted, and/or for each information model that is modified, the information model updater/generator module 113 may verify that data source(s) 125, data pipeline component(s) 127, and/or target(s) 129 exist that are of the types of data source(s), data pipeline component(s), and/or target(s) indicated in the specification of the information model, and which are permitted to be controlled via the DPIC 110. In other words, the information model/updater generator module 113 may first verify that the data pipeline infrastructure 120 is able to fulfill requests that may invoke the information model. In one example, the information model updater/generator module 113 may communicate with the data pipeline component discovery module 118 to complete this task. For instance, data pipeline component discovery module 118 may maintain an inventory of all of the available data pipeline infrastructure 120 (e.g., data source(s) 125, data pipeline components 127, target(s) 129, etc.).

In one example, each time a component is added to the data pipeline infrastructure 120, a notification may be provided to the data pipeline component discovery module 118. For instance, each of the data pipeline components 127 may be configured to self-report an instantiation and/or a deployment. Alternatively, or in addition, a software defined network (SDN) controller that is responsible for deploying one of the data pipeline components 127 may transmit a notification to the data pipeline component discovery module 118. Similarly, a user who is responsible for deploying one of the data pipeline components 127 may be responsible for a notification to the data pipeline component discovery module 118 (e.g., via one of the client devices 188).

It should be noted that new information models may be submitted in connection with a request fulfillment process, or may be submitted without connection to a particular request. For instance, a user may develop an information model for a new anticipated use case, without having a specific request for which a data pipeline is to be immediately built. In one example, a user, e.g., via one of the client devices 188 may browse the catalog of the information model repository 114 and may utilize any existing information models as a template for a new information model. As illustrated in FIG. 1, the interactions of DPIC 110 and one of the client devices 188 for generating and/or submitting a new information model may be via information model updater/generator module 113. However, in another example, the information model repository 114 may alternatively or additionally comprise an application programming interface (API) which may allow more direct access of the catalog of information models from the one of the client devices 188. In one example, user objects, information model objects, and data pipeline component type objects are all first class citizens in the architecture so any user could act on (view) any information model/template or data pipeline component type. In addition, there may be no unnecessary hierarchical control imposed over the inventories that would reduce data sharing and limit automation. In accordance with the present disclosure, each object may have an intrinsic identity, may be dynamically constructed at runtime, and may be passed as a parameter.

Once an information model is selected and finalized (e.g., approved for use and/or not objected to), and/or different functions, technologies, and/or licenses are combined in accordance with the combining module 119 that is applied to the request 197, the request interpreter and fulfillment module 111 may also verify that the client device 188 and/or a user thereof is authorized to create a data pipeline with regard to the data being requested, that the desired target(s) 129 are permitted to receive the requested data, that the client device 188 and/or a user thereof is permitted to utilize particular data pipeline components types that are indicated in the specification, and so forth. For instance, the request interpreter and fulfillment module 111 may submit the specification to authorization module 112 along with an identification of the one of the client devices 188 and/or an identification of a user thereof. Authorization module 112 may maintain records of the permissions for various ones of the client devices 188 and/or various users or user groups, the permissions of various data pipeline component types, the permissions for specific ones of the data pipeline components 127, data source(s) 125, and/or target(s) 129, and so forth. In one example, authorization module 112 may additionally include information regarding user preferences, limitations, exception handling procedures, etc. If the records associated with the user, the one of the client devices 188, the data pipeline component type(s), etc. are indicative that a data pipeline may be built or adapted to fulfill the request 197 in accordance with the selected information model, then the authorization module 112 may return an positive confirmation, or authorization, to the request interpreter and fulfillment module 111. In addition, upon receipt of a positive confirmation/authorization the request interpreter and fulfillment module 111 may submit the selected information model (e.g., along with parameters of the request 197), to the data pipeline management and assembly (DPMA) module 117.

In one example, the DPMA module 117 is responsible for generating a data pipeline or reconfiguring a data pipeline to fulfill the request 197 in accordance with the information model that is selected (such as information model 195) and/or the functions, technologies, and/or licenses that are combined. For instance, the DPMA module 117 may decompose the specification of the information model 195 into mini-specifications for driving data retrieval and data joins, e.g., one mini-specification per data source. For instance, in the present example, information model 195 may comprise or provide a specification which may result in the establishment and/or reconfiguration of the data pipeline 121, which may include A1, B1, C, and D from data pipeline components 127. In one example, a higher-level specification may be delivered to intermediate points to merge data streams. To illustrate, the DPMA module 117 may determine that the information model provides a roadmap for establishing a data pipeline for delivering base station performance data from one or more data sources to one or more targets. The request parameters may provide information regarding the geographic scope of the request. In one example, the DPMA 117 may select particular data sources of data sources 125 having the requisite base station performance data in accordance with the geographic scope information. In one example, the determination may be made using information stored in data pipeline component discovery module 118.

In one example, the information model may indicate that an aggregator component is called for as a first intermediate node in data pipeline 121. DPMA 117 may determine that there are multiple aggregator components available in the data pipeline infrastructure (e.g., A1 and A2). However, DMPA 117 may select one of these in accordance with the request parameters, e.g., using the geographic scope information, using information regarding the distance or latency from the data source(s) 125 (e.g., after selecting the appropriate data source(s) 125), and so forth. For instance, in the present example, DPMA 117 may select an aggregator component A1 from the available data pipeline components 127. It should be noted that DPMA 117 may select additional data pipeline components B1, C, and D from the available data pipeline components 127 following a similar analysis.

In one example, DPMA 117 may instantiate the data pipeline 121 in response to the request 197 (or in response to an instruction from the request interpreter and fulfillment module 111 containing the selected information model and parameters of the request 127). In one example, DPMA 117 may configure the data pipeline components A1, B1, C, and D in accordance with hooks in the information model and/or specification which invoke data schemas associated with the respective data pipeline components types of the data pipeline components A1, B1, C, and D. For instance, a data schema for data pipeline component A1 may indicate the available commands which may be used to configure data pipeline component A1, the values of different arguments or parameters which may be used in one or more commands, and so forth. In one example, the hooks in the information model (e.g., information model 195) may be executed by DPMA 117 to retrieve or to invoke the respective data schemas. However, specific configuration commands may be tailored to the particular data pipeline components 127 that are selected (e.g., to direct configuration commands to A1 (and not to A2), to B1 (and not to B2), to C, and to D). Accordingly, using the various data schemas, DPMA 117 may configure the data pipeline components A1, B1, C, and D to function as data pipeline 121 and to move the requested data from the one or more of data sources 125 to one or more of targets 129.

To illustrate, data pipeline component A1 may be configured to obtain base station operational data from at least two of the data sources 125 and to aggregate the data at the node. For instance, data pipeline component A1 may utilize Apache Kafka, Data Movement as a Platform (DMaaP), nanomsg, or the like to “subscribe” to the data from the relevant data sources 125. In one example, data pipeline component A1 may also be configured to periodically forward the aggregated data to data pipeline component B1. Data pipeline component B1 may be configured to generate summary data, such as 5 minute moving averages, etc., to pare the data, such as removing extra fields, and so forth. Data pipeline component C may be configured to obtain summary data from data pipeline component B1 (e.g., again using Kafka, DMaap, nanomsg, or the like), to smooth the data and remove any outliers, and to place the processed data into a JSON format. Lastly, data pipeline component D may be configured to periodically obtain the data that is further processed from data pipeline component C, to store a copy of the processed data, and to forward the processed data to the desired one or more of targets 129.

It should be noted that in one example, parameters of the request 197 may indicate a limited temporal scope of the requested data. As such, in one example, DPMA 117 may configure the data pipeline components A1, B1, C, and D to cease the specific functions configured for data pipeline 121 after the temporal scope of the request has passed. However, it should also be noted that as indicated above, the data pipeline component discovery module 118 may maintain information regarding the availability and current configurations of data pipeline components 127, the data pipeline 121, other data pipelines, etc. As such, in one example, all or a portion of the data pipeline 121 (e.g., the configurations of any one or more of the data pipeline components A1, B1, C, and D) may be maintained after the fulfillment of the request 197, such as if a new request is received and processed by DPIC 110 and if it is determined that the same data is being requested. Thus, for example, the data may be maintained in data pipeline component D for an additional time duration so as to fulfill this additional request. For instance, there may be one or more predictors that suggest that one or more of the data sources 125 may be reused again based on historical trends.

Alternatively, or in addition, the new request may be for obtaining data that partially overlaps with the data requested in request 197. For instance, the new request may be for similar base station operational data having the same geographic scope, but for a more extended time period, or for a time period that partially overlaps with a time period specified in the request 197. In such case, DPMA 117 may maintain the data pipeline 121 for an additional duration so as to obtain the additional data associated with the time period of the new request. Additional scenarios may also lead to the full or partial reuse of data pipeline 121 or other data pipelines. For instance, in another example data pipeline 121 may be integrated with another data pipeline, may be expanded with one or more additional data pipeline components to fulfill a new request (such as adding an additional aggregator for obtaining additional base station operational data from an additional geographic region), and so forth. DPMA 117 may maintain an underlying source feed process that a plurality of data pipeline instances depend on, as long as a subset of the data pipeline instances continue to exist. DPMA 117 may be able to reduce the frequency of enrichment, or lower other characteristics of one or more of the remaining data pipelines instances to compensate for new resulting requirements of any or all of the remaining data pipeline instances.

To further illustrate, in one example, data pipeline 121 may be in existence (e.g., having been created configured, and either in-use or remaining idle/in standby mode) prior to the request 197. In such case, similar to the example above, DPMA module 117 may determine that the information model provides a roadmap for establishing a data pipeline for delivering base station performance data from one or more data sources to one or more targets. The request parameters may provide information regarding the geographic scope of the request. Thus, the DPMA 117 may select particular data sources of data sources 125 having the requisite base station performance data in accordance with the geographic scope information. In one example, the determination may be made using information stored in data pipeline component discovery module 118. However, the information stored in data pipeline component discovery module 118 may also indicate that data pipeline 121 is operational within the data pipeline infrastructure 120 and is available to fulfill the request 197. In this case, the nodes of data pipeline 121 (e.g., data pipeline components A1, B1, C, and D) may be reconfigured to fulfill the request 197. For instance, the data pipeline components A1, B1, C, and D may be configured/reconfigured using commands via the respective data schema to obtain additional data within the temporal and geographic scope of the request 197, to forward the processed data to one or more of the targets 129 via data pipeline component D, and so forth.

In still another example, the DPMA module 117 may determine in accordance with the information model selected for request 197 that the requested data may already be stored, e.g., at data pipeline component D. For instance, data pipeline component D may have come into possession of the data in accordance with a different request for which the data pipeline 121 was established. In such an example, data pipeline component D may also store extra data that is not relevant to request 197. However, in such case, DPMA 117 may establish a new, shortened data pipeline to fulfill request 197. For instance, the data pipeline may comprise data pipeline component D (and in one example, the one or more target(s) 129, which may also be considered part of the data pipeline). In such case, the configuration may involve configuring the target(s) 129 as subscribers to a data feed from data pipeline component D comprising the portion of the data stored therein that is pertinent to the request 197.

In still another example, the DPMA module 117 may determine that the data pipeline components A1, B1, C, and D may be configured as part of a new virtual data pipeline or channel within the data pipeline that combines different functions, technologies, and/or licenses. Thus, the DPMA module 117 may create a new data pipeline that combines the components A1, B1, C, and D into a single component via the combination of different functions, technologies and/or licenses.

It should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like, additional clouds, and so forth.

It should also be noted that the modules of DPIC 110, the interrelationships and connections shown in FIG. 1, and so forth are illustrative of just one example of how DPIC 110 may be organized and configured. For example, data pipeline component discovery module 118 may be split into two modules, with a separate module to keep track of active and inactive data pipelines, while data pipeline component discovery module 118 may continue to maintain an inventory of individual data pipeline components 127. In still another example, an additional module may be provided to store previously processed requests as request templates, to store request templates and the associations between request templates and information models, to provide the request templates to clients, to obtain feedback on the matching of requests and/or request templates to information models (and/or the resulting data pipelines), to learn and update associations between request templates and information models, and so forth. Thus, these and other modifications are all contemplated within the scope of the present disclosure.

FIG. 2 illustrates a block diagram of an example of the combining module 119 illustrated in FIG. 1. In one embodiment, the combining module 119 may include a function combining module 202, a technology combining module 204, a license combining module 206, and a combining support repository (CSR) 208. As illustrated in FIG. 1, the combining module 119 may be in communication with the request interpreter and fulfillment module 111 and the DPMA module 117. The request interpreter and fulfillment module 111 may access the combining module 119 to determine if one or more functions, technologies, and/or licenses can be combined. The DPMA module 117 may then apply the combination of functions, technologies, and/or licenses for the data pipeline that is modified or created in accordance with the combination of one or more functions, technologies, and/or licenses.

In one embodiment, the function combining module 202 may combine two or more functions from one or more data pipelines. A function may be an operation that is performed on the data. For example, functions may include data source identification, data collection, data distribution, data ingestion, data extraction, data transformation, data analytics, and the like.

In one embodiment, the technology combining module 204 may allow the DPIC 110 to combine two or more technologies to dynamically or statically construct a virtual pipeline that can apply the two or more technologies. In one embodiment, the technologies may be applied to perform the functions that are combined by the function combining module 202. A technology may be a specific code or program that contain instructions when executed by a processor to perform a particular function. Different technologies can be created to perform the same function (e.g., two different technologies may perform data source identification).

In some instances, a technology may be a third party technology. The third party technology may also require a license to use the technology. Third party technologies may include NiFi technology, Palantir technology, and the like, for data ingestion.

In one embodiment, the license combining module 206 may combine two or more licenses for any data of the data sources 125 that may be proprietary and/or technologies that may require a license. The license combining module 206 may determine a maximally available use of licenses within a service provider's network to allow a data pipeline to efficiently leverage available licenses.

For example, some licenses may allow a certain number of active uses of a particular technology. At a given time, some capacity of the number of uses may be available for a technology. In other words, the technology may not be used up to the maximum allowable limit associated with the license for the technology. Thus, the license combining module 206 may search for available licenses and combine the licenses for two or more different technologies and/or data sources 125 to create a new data pipeline for a request 197.

In one embodiment, the license combining module 206 may include a plurality of sub-modules. For example, the sub-modules may include a license specification map (LSM), a license usage map (LUM), a smart ruleset map (SRM), a smart correlator (SC), a smart normalizer (SN), and a smart licenser (SL). In one embodiment, the LSM may contain a link to procurement license specification data stores (PLSD), which may store artifacts for all technology capabilities and license details. The LSM may include a graphic relationship among all technology modules that are available in the enterprise or to the network 100. The graphic representation may be a product of the SC described below.

In one embodiment, the LUM may be a proxy of the real license usage data store with real-time reflection of license usage state and/or status for all technology modules, or their corresponding bundles. Bundles meaning multiple technologies that can be combined by the technology combining module 204 to perform a function.

In one embodiment, the SRM may contain various rulesets for the licenses. The rules may be the heart of the license combining module 206. The SRM may include further submodules with rulesets to intelligently determine the best alternatives at runtime. The SRM may have license rules and entitlement rules for each technology or each bundle of technologies.

In one embodiment, the SRM may include rulesets such as stretch rules, exchange rules, compatible rules, and the like. The stretch rules may be negotiated with various vendors or independent developers/suppliers. An example of a stretch rule may be “limited to 10,000 concurrent sessions, but this is just an average over an 8 hour period.”

In one embodiment, the exchange rules may refer to a vendor that offers multiple technologies. If one technology is under-utilized for a period of time, its rights can be transferred to another technology which may be heavily used at peak traffic hours.

In one embodiment, compatible rules may specify what technologies may be compatible with other technologies. The compatible rules may be shared with the technology combining module 204. The technology combining module 204 may use the compatible rules to determine which technologies can be combined to perform a function or combination of functions. The LSM may use the compatible rules to calculate the cost/benefit ratio to combining the technologies. The compatible rules may be edited manually or through an analysis of vendor provided specifications.

In one embodiment, the SC may play two front-end roles. First, the SC may function as a gatekeeper for any newly negotiated license specifications. The SC may adapt the license specification input and convert it to a common format to ensure each and every license specification can be restructured to the common format. Second, the SC may fetch these common specifications to create a graphic representation of all compatible technologies with their associated license terms. The derived graphic representation may be stored in the LSM. The SC may offer a viewer utility to allow an application or operator to observe compatible technology possibilities. However, not all technologies may be exchanged freely. Exchange rules may be defined in the compatible rules in the SRM, as discussed above.

In one embodiment, the SN may provide real-time support to allow the smart licenser, defined below, to make error free intelligent license shuffling decisions. The SN may rely on the stretch rules to perform normalization. The SN may look into the LUM and overall usage patterns to recommend how the SN should make an alternative license decision. For example, if a first technology is a better solution than a second technology for a given request, but the first technology license is maxed out per the license specification, then the SN may calculate an average usage number to determine if the stretch rule can be applied and may still recommend the first technology for the request. In some instances, the SN may create runtime ad hoc rules to be placed in the smart ruleset to bypass existing rules and to speed up the runtime performance. The SN may, in some cases, make certain rulesets to be temporarily inactive for a period of time.

In one embodiment, the SL may play the role as the executor of the LCM. The SL may leverage information in the LSM, the LUM, and the SRM to determine the optimal way to combine licenses. The SL may incorporate resource usage cost and benefit mathematic modules to recalculate the overall needs and associated savings. However, the SL may not dictate the combining solution. It is the job of the technology combining module 204 to determine available alternatives. The SL may find the least cost option without suffering the overall effectiveness or find the best upgradable solution in enhancing the overall effectiveness without costing more.

In one embodiment, the function combining module 202, the technology combining module 204, and the license combining module 206 may have a hierarchical relationship. For example, the function combining module 202 may be accessed first on top of the hierarchy by the request interpreter and fulfillment module 111. If two or more functions can be applied, then the request interpreter and fulfillment module 111 may attempt to apply the technology combining module 204 to combine two or more technologies to perform the two or more functions to be combined. If two or more technologies can be combined, then the request interpreter and fulfillment module 111 may attempt to apply the license combining module 206 to determine if any of the technologies and/or data sources are associated with a license and if capacity is available under the license.

For example, a technology selected by the technology combining module 204 may require up to 40% of the available license of a technology. The technology module 204 may determine that technology A or technology B may be used. The license combining module 206 may determine that 80% of the available licenses for technology A is consumed and that only 30% of the available licenses for technology B is consumed. Thus, the technology combining module 204 may select technology B to fulfill a request. Notably, the correct technology may be selected based upon the availability of licenses for each technology without the details being exposed to a requestor.

In one embodiment, the function combining module 202, the technology combining module 204, and the license combining module 206 may be independently accessed. In other words, access to the function combining module 202, the technology combining module 204, and the license combining module 206 may not depend on access to another one of the modules in any type of order or hierarchical relationship.

In one embodiment, the CSR 208 may be a memory or database that stores a variety of repositories to help the request interpreter and fulfillment module 111 determine if the function combining module 202, the technology combining module 204, and/or the license combining module 206 can be applied to the request 197. In one embodiment, the CSR 208 may include information models, a flow model, a policy combiner, and data pipeline module states (DMS).

In one embodiment, the information model repository may include information associated with each information model that is built to support an execution strategy for a given data request type. Each data request may be analyzed and then mapped to a corresponding information model, as described above with reference to FIG. 1. In one embodiment, the information model repository may be the information model repository 114, illustrated in FIG. 1.

In one embodiment, the flow model repository may include flow models that depict an executable number of steps and/or tasks to complete the request 197. The flow model may be mapped and when information is traversed, the mapped flow model may be executed. One information model, depending on the complexity, may be mapped to multiple executable flow models.

In one embodiment, the policy combiner repository may store combined policies that are created to support the information model transversal, as well as flow model execution. These policies introduce the dynamic nature of the function combining module 202, the technology combining module 204, and the license combining module 206. The policy combiner repository may update rules associated with licenses and an indication of whether some licenses can be combined. New policies associated with changing licenses can influence how the information model is mapped to a requestor and how flow paths can be altered based on new rules.

In one embodiment, the DMS may contain real-time information of the runtime state of all data pipelines 121. In other words, the DMS may contain the topological view of all data pipelines 121 as well as their health condition at a given point in time. The DMS may enable the combining module 119 to make runtime decisions if a combination of functions, technologies, and/or licenses are available to accomplish a new request 197.

In operation, the combining module 119 may operate as follows. In one embodiment, the request 197 may be received by the request interpreter and fulfillment module 111, as described above. The request interpreter and fulfillment module 111 may begin executing a fulfillment that is requested by traversing the associated information model and its corresponding executable flows, as described above. The request interpreter and fulfillment module 111 may detect a combining hook as the associated information model and corresponding executable flows are traversed.

The request interpreter and fulfillment module 111 may then invoke the combining module 119. In one embodiment, the DPMA 117 may access the CSR 208 to provide information to the request interpreter and fulfillment module 111 from the information model repository, flow model repository, policy combiner repository, and the DMS repository to determine which functions, technologies, and/or licenses can be combined based on the available information.

With an overview of the current state of the data pipelines from the CSR 208, the request interpreter and fulfillment module 111 may then invoke the function combining module 202, the technology combining module 204, and/or the license combining module 206. In one embodiment, the request interpreter and fulfillment module 111 may access the function combining module 202, the technology combining module 204, and/or the license combining module 206 in accordance with the hierarchical relationship. In another embodiment, the request interpreter and fulfillment module 111 may access the function combining module 202, the technology combining module 204, and/or the license combining module 206 independent of one another as needed to combine two or more functions, technologies, and/or licenses. Once the two or more functions, technologies, and/or licenses are combined, the request interpreter and fulfillment module 111 may create a new data pipeline or modify an existing data pipeline in accordance with the combined functions, technologies, and/or licenses.

FIG. 3 illustrates a flowchart of an example method 300 for generating a data pipeline based on combined functions, technologies, and/or licenses, in accordance with the present disclosure. In one example, the method 300 is performed by a component of the system 100 of FIG. 1, such as by the DPIC 110, and/or any one or more components thereof (e.g., a processor, or processors, performing operations stored in and loaded from a memory and comprising any one or more of the modules 111-119). In one example, the steps, functions, or operations of method 300 may be performed by a computing device or system 400, and/or processor 402 as described in connection with FIG. 3 below. For instance, the computing device or system 400 may represent any one or more components of a DPIC that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system.

The method 300 begins in step 302. At step 304, the processing system may receive a data request. The data request may be a request to receive data from a data source to a target via a data pipeline. The data pipeline may be a virtual pipeline that may include one or more channels to transmit the data from the data source to the target. In one embodiment, the data request may include a request to perform one or more functions on the data source in real-time as the data is transmitted across the data pipeline.

At step 306, the processing system may execute a request fulfillment module to determine at least one information model and at least one executable flow associated with the data request. In one embodiment, a DPIC may control the request fulfillment module (e.g., the request interpreter and fulfillment module 111) to interpret the data request, as described above. For example, the request fulfillment module may map at least one information model to the data request and one or more executable flows to the data request based on information received in a CSR of a combining module or using an ontology and data scheme repository, as described above.

At step 308, the processing system may determine that at least one combining module is available to be applied to the data request based on the at least one information model and the at least one executable flow that is determined. In one embodiment, the request fulfillment module may traverse the information model and flow models of the data request. The request fulfillment module may come across a combining hook to indicate that functions, technologies, and/or licenses can be combined to execute the data request over a modified or newly created data pipeline. When the combining hook is detected, the request fulfillment module may invoke one or more combining modules.

At step 310, the processing system may apply the at least one combining module to the data request. In one embodiment, the combining module may include a function combining module, a technology combining module, a license combining module, and a CSR. The CSR may provide an overview of the states of current data pipelines, rules associated with how policies or rules of various licenses can be combined, and information associated with information models and flow models. Based on the information from the CSR, the request fulfillment module may invoke the function combining module, the technology combining module, and/or the license combining module to determine if two or more functions, technologies, and/or licenses can be combined in a data pipeline to fulfill the data request. If two or more functions, technologies, and/or licenses can be combined, the two or more functions, technologies, and/or licenses can be combined in a data pipeline.

At step 312, the processing system may generate a data pipeline to transmit data to a target that initiated the data request, wherein the data pipeline is generated in accordance with the at least one combining module that is applied. In one embodiment, the data pipeline may be a virtual data pipeline that can execute the data request in accordance with the at least one combining module that is applied. In one embodiment, the data pipeline can be generated by creating a new data pipeline or modifying an existing data pipeline with the at least one combining module. At step 314, the method 300 ends.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the method 300 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for generating a data pipeline based on combined functions, technologies, and/or licenses, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for generating a data pipeline based on combined functions, technologies, and/or licenses (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for generating a data pipeline based on combined functions, technologies, and/or licenses (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
receiving, by a processing system including at least one processor, a data request;
executing, by the processing system, a request fulfillment module to determine at least one information model and at least one executable flow associated with the data request;
determining, by the processing system, that at least one combining module is to be applied to the data request based on the at least one information model and the at least one executable flow;
applying, by the processing system, the at least one combining module to the data request; and
generating, by the processing system, a data pipeline to transmit data to a target that initiated the data request, wherein the data pipeline is generated in accordance with the at least one combining module that is applied.

2. The method of claim 1, wherein the request fulfillment module is for accessing a combining support repository to determine the at least one information model and the at least one executable flow.

3. The method of claim 1, wherein the combining support repository comprises information models, flow models, a policy combiner, and a data pipeline module state.

4. The method of claim 3, wherein each information model of the information models is to support an execution strategy for a given data request type and one of the information models is mapped as the at least one information model to the data request.

5. The method of claim 3, wherein each flow model of the flow models depicts executable steps to be completed for a given data request, wherein the at least one information model that is mapped to the data request is mapped to one or more of the flow models.

6. The method of claim 3, wherein the policy combiner is for storing rules associated with how the information models are mapped to a data request and how the information models are mapped to one or more of the flow models.

7. The method of claim 6, wherein the rules in the policy combiner are periodically updated with new rules.

8. The method of claim 3, wherein the data pipeline module state comprises a state of one or more data pipelines that are currently active.

9. The method of claim 8, wherein the request fulfillment module is for applying the at least one combining module based on the data pipeline module state.

10. The method of claim 1, wherein the at least one combining module comprises a function combining module, a technology combining module, or a license combining module.

11. The method of claim 10, wherein the function combining module is to combine two or more data functions for the data pipeline.

12. The method of claim 11, wherein the data functions comprise a data source identification function, a data collection function, a data distribution function, a data ingestion function, a data extraction function, a data transformation function, or a data analytics function.

13. The method of claim 10, wherein the technology combining module is to combine two or more data technologies for the data pipeline.

14. The method of claim 13, wherein the license combining module is to combine two or more licenses for the two or more data technologies that are combined.

15. The method of claim 10, wherein the license combining module is to combine two or more licenses associated with data sets that are requested in the data request.

16. The method of claim 10, wherein the function combining module, the technology combining module, and the license combining module have a hierarchical relationship.

17. The method of claim 10, wherein the request fulfillment module is to apply the at least one combining module in a sequential order of the function combining module, the technology combining module, and the license combining module.

18. The method of claim 1, wherein the request fulfillment module is controlled by a data pipeline intelligent controller.

19. A non-transitory computer-readable medium storing instructions which, when executed by a processing system including at least one processor, cause the processing system to perform operations, the operations comprising:
receiving a data request;
executing a request fulfillment module to determine at least one information model and at least one executable flow associated with the data request;
determining that at least one combining module is to be applied to the data request based on the at least one information model and the at least one executable flow;
applying the at least one combining module to the data request; and
generating a data pipeline to transmit data to a target that initiated the data request, wherein the data pipeline is generated in accordance with the at least one combining module that is applied.

20. An apparatus comprising:
a processing system including at least one processor; and
a computer-readable medium storing instructions which, when executed by the processing system, cause the processing system to perform operations, the operations comprising:
receiving a data request;
executing a request fulfillment module to determine at least one information model and at least one executable flow associated with the data request;
determining that at least one combining module is to be applied to the data request based on the at least one information model and the at least one executable flow;
applying the at least one combining module to the data request; and
generating a data pipeline to transmit data to a target that initiated the data request, wherein the data pipeline is generated in accordance with the at least one combining module that is applied.
